(19) United States
(12) Patent Application Publication
(10) Pub. No.: US 2006/0178812 A1
(43) Pub. Date: Aug. 10, 2006

(54) Computer-based dispatching system and method

(76) Inventors: Sheldon Affleck, Regina (CA); Lavern Affleck, Regina (CA)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/314,812

(22) Filed: Dec. 21, 2005

(30) Foreign Application Priority Data
Dec. 21, 2004 (CA) 2,490,540

(51) Int. Cl. G01C 21/36

(52) U.S. Cl. 701/201; 701/200; 701/213

(57) ABSTRACT

A system and method is disclosed that provides for the scheduling of delivery jobs using estimated arrival times that are repeatedly updated while the delivery job progresses. A number of delivery vehicles are dispatched on a first set of delivery jobs such that the delivery vehicles are scheduled to arrive at a bottleneck point at intervals, to prevent delays at the bottleneck point. As each delivery vehicle progresses on an assigned delivery job, location information of the delivery vehicle is used to update an estimated time of arrival at the bottleneck point. When a delivery vehicle completes an assigned delivery job and is ready to be dispatched on a remaining delivery job, the estimated delivery durations of the remaining delivery jobs and the estimated times of arrival of the delivery vehicles currently on assigned delivery jobs are used to assign one of the remaining delivery jobs to the delivery vehicle.

This invention is in the field of GPS-based information systems for vehicle fleets and more specifically for dispatching systems and methods based on GPS-based information.

### BACKGROUND

The movement of goods and materials between locations using a fleet of delivery vehicles is often an intensive and complicated process. In conventional goods and material delivery systems between locations, such as moving agricultural commodities from farms to a commercial facility such as a processing plant, considerable time usually elapses between delivery of the commodity from the farm to a commercial facility and eventual processing of the commodity at the commercial facility.

If a fleet of delivery vehicles is collecting goods or material from a number of different pickup locations and delivering the goods and materials to relatively few delivery locations, there are often bottlenecks in the system at the delivery locations. For example, if a fleet of delivery vehicles are dispatched to a number of farmer's grain storage facilities on the farmer's land, to load the grain and deliver it to a central grain processing plant, the central grain processing plant will only be able to unload and process so many loads of grain at any given time. The result is that if too many delivery vehicles arrive at the central grain processing plant at the same time, there will be delays while the delivery vehicles have to line up in order to unload.

Alternatively, in some delivery systems, the locations where the goods and materials are loaded into the delivery vehicles can be the bottlenecks, such as a cement plant for example. A cement plant might have a fleet of delivery vehicles (cement trucks) that deliver cement to a number of different delivery locations, however, the cement plant will only have the facilities to load so many of the cement trucks at any given time. If too many cement trucks arrive at the cement plant for loading at one time, some of the cement trucks will have to wait in line to load.

On the other hand, while having too many delivery vehicles arriving at a location at a given time might cause inefficiencies, not having any delivery vehicles arrive at that location for a period of time can create just as many inefficiencies, by creating downtime in the system. Typically, in order to prevent the downtime of operations that require a constant supply of materials or goods in order to operate, an organization will have storage facilities on the premises so that a surplus of necessary goods and services required for an operation can be stored and used in the operation as it is needed. Often these storage facilities are quite extensive, but the storing of this surplus allows delivery vehicles delivering the goods and materials to the location to arrive at fairly sporadic intervals and not affect the operations of the plant because the plant can operate using the stored surplus.

This storing of surplus approach, is the approach commonly taken by conventional grain and other crop processing facilities. Typically, these facilities will store large volumes of surplus material to be processed. The disadvantages of this however is that the commodity can be stored in the facility for considerable lengths of time which will involve inventory costs because the commodity will typically have to be owned by the organization before it is eventually processed and sold again and there are also risks associated with the storage which could entail additional costs, such as insurance.

Ideally, the most efficient use of a fleet of delivery vehicles would be to have the delivery vehicles arrive with their loads at constant intervals so that there is always another delivery vehicles ready to unload without a long line of delivery vehicles waiting at the terminal to unload their loads or large gaps between the arrival of delivery vehicles that will involve downtime of the unloading facilities.

In some cases, an operator of a delivery vehicle fleet will attempt to dispatch the delivery vehicles so that they arrive at the delivery location at fairly regularly spaced intervals. The dispatcher will attempt to estimate the delivery time of the different delivery jobs to be performed and try to dispatch the delivery vehicles in some sort of order so that the delivery trucks will arrive at the delivery location (or alternatively the loading location) at fairly regular intervals.

While this manual dispatching functions adequately initially, real world conditions and imprecise initial estimates can often greatly affect the results of this method. Heavy traffic, driver error, unexpected road construction, weather, unexpected breakdowns, etc. can all render the dispatchers initial estimates inaccurate. Also, over long distances, the simple fact that different drivers often drive at different speeds can greatly affect the accuracy of the initial estimates. While these inaccuracies may not create too many problems in the initial set of delivery jobs, as each of the delivery vehicles makes its delivery and is dispatched to another delivery job, the inaccuracies in the estimates can be compounded causing the entire method to be inaccurate. As the delivery vehicles get dispatched to new delivery job after new delivery job, the delivery time estimates can get less and less accurate because they are being based on other inaccurate estimates of delivery times, until the delivery vehicles are arriving at their locations at completely irregular intervals.

In some cases, delivery vehicles in a fleet may be equipped with two-way communication devices, such a radios, so that a dispatcher can attempt to keep track of the approximate progress and location of each of the vehicles in the fleet, but again this depends upon the driver's description of his location and the estimations of the dispatcher and can still be incredibly difficult for the dispatcher to try to estimate delivery times with any accuracy. Additionally, it is impractical for a driver to be constantly relaying his position to an operator at relatively small intervals and if the fleet is relatively large there could be extremely labor intensive to be in contact with all of the drivers in the fleet, even at long intervals.

### SUMMARY OF THE INVENTION

It is an object of the present invention to provide a system and method for scheduling the dispatch of vehicles that overcomes problems in the prior art.

In one embodiment, a system for automatically dispatching a plurality of delivery vehicles on a plurality of delivery jobs is disclosed. The system comprises: a plurality of location tracking devices operative to transmit the location information over a wireless communication medium, wherein a location tracking devices is located in each delivery vehicle; a receiver operative to receive location information from the plurality of location tracking devices; and a computer operatively connected to the receiver, the computer comprising: a processing unit; a memory storage device operatively connected to the processing unit; and a program module stored in the memory storage device operative for providing instructions to the processing unit, the processing unit responsive to the instructions of the program module. The program module is operative for: calculating an estimated delivery duration for each of the delivery jobs; determining an initial dispatch schedule, wherein each of the delivery vehicles is assigned a delivery job based on the estimated delivery duration calculated for the delivery job, wherein the estimated delivery durations are coordinated such that the delivery vehicles are scheduled to arrive at a bottleneck point at intervals; during the course of each assigned delivery job, regularly receiving location information transmitted by each of the location tracking devices and using the location information to calculate an updated estimated time of arrival at the bottleneck point; and when a delivery vehicle completes an assigned delivery job, using the estimated delivery durations of the remaining delivery jobs and the updated estimated times of arrival at the bottleneck point of the delivery jobs in progress, assigning a remaining delivery jobs to the delivery vehicle such that the estimated delivery duration of the delivery job has the delivery vehicle scheduled to arrive at the bottleneck point at an interval with respect to the delivery jobs in progress.

In a second embodiment, a method for automatically dispatching a plurality of vehicles on a plurality of delivery jobs is disclosed. The method comprises: calculating an estimated delivery duration for each of the delivery jobs; determining an initial dispatch schedule, wherein each of the delivery vehicles is assigned a delivery job based on the estimated delivery duration calculated for the delivery job, wherein the estimated delivery durations are coordinated such that the delivery vehicles are scheduled to arrive at a bottleneck point at intervals; during the course of each assigned delivery job, regularly receiving location information from a location tracking device located in each of the delivery vehicles and using the location information to calculate an updated estimated time of arrival at the bottleneck point; and when a delivery vehicle completes an assigned delivery job, using the estimated delivery durations of the remaining delivery jobs and the updated estimated times of arrival at the bottleneck point of the delivery jobs in progress, assigning a remaining delivery job to the delivery vehicle such that the estimated delivery duration for the delivery job has the delivery vehicle scheduled to arrive at the bottleneck point at an interval with respect to the delivery jobs in progress.

The present system and method provides for the scheduling of delivery vehicles using estimated times of delivery that are constantly being updated with real world data to provide timely estimates. Initial estimates of delivery times for delivery jobs are updated at regular intervals while the delivery job is being performed to provide more accurate estimates of delivery times for the vehicle. In this manner, inaccuracies in initial estimates and unforeseen circumstances are taken into account by the system and the scheduling of the dispatches of later delivery jobs uses these timely estimates to increase the accuracy of the overall scheduling.

The present method and system schedules the dispatching of a plurality of delivery vehicles to perform a number of delivery jobs. Typically, there will be more delivery jobs than delivery vehicles so that when a delivery vehicle finishes a delivery job it will be dispatched to perform another delivery job.

For each delivery job to be performed, an estimate of the time needed to perform the delivery job is made. Using these estimated times to complete each of the delivery jobs, an initial schedule of dispatch orders is determined for each of the delivery vehicles. The assigning of the initial dispatch orders is done in a manner so that the delivery vehicles are assigned to delivery jobs that are estimated to end at regular intervals.

As the plurality of delivery vehicles proceed with the delivery jobs assigned to them, each of the delivery vehicles is equipped with a location transmitting device. These location transmitting devices are operative to send location information about the delivery vehicle they are located in to a base station so that the base station is updated as each vehicle progresses on its assigned delivery job and the estimated time to arrival at a bottleneck point in the delivery job is updated on a regular basis, improving the accuracy of the estimates.

When a delivery vehicle has finished a delivery job and is ready to be dispatched to another delivery job, the delivery vehicle will be dispatched on a remaining delivery job, after evaluating the estimated delivery duration times of the remaining unassigned delivery jobs and the updated estimated time of arrival of the delivery jobs currently being performed.

Because location information collected by the location transmitting devices will be transmitted to the base station, data can be collected at the base station to make a complete electronic record corresponding to each delivery job. The electronic record can indicate which delivery vehicle was used to complete the delivery job and contain a complete log of all the location information transmitted by the location transmitting device during the delivery job.

The present system and method allows the scheduling of a fleet of delivery vehicles based on estimates of completion times for deliveries that are updated on a regular basis based on actual measurements to increase the accuracy of the estimated completion times and provide a more accurate scheduling of deliveries.

A typical application of the present system and method would be in the coordination of a delivery fleet that is picking up loads of agricultural commodity from remote locations, such as farmers' storage facilities, and delivering the agricultural commodity to a processing plant to be processed. Using the present system and method, a fairly constant delivery of agricultural commodity to the processing plant could occur allowing the processing plant to operate at a fairly constant rate without requiring a large surplus of the commodity to be stored at the site of the processing plant waiting to be processed.

While the present system is contemplated as being useful in the processing of agricultural commodities, there are numerous other applications where it could also be beneficial. For example, a cement producing plant could use it to coordinate the loading of their cement trucks at the cement producing plant and delivery of the cement to a number of different delivery locations. The present system and method could also be applicable to such diverse fields as garbage collection where it can be used to schedule garbage collection to neighborhoods at varying transport distances to prevent garbage collection vehicles from having to wait to unload the collected waste at the garbage collection facilities.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 illustrates a single delivery vehicle belonging to a fleet of vehicles in communication with a base station in accordance with a dispatching system of the present system;

FIG. 2 is a schematic illustration of an embodiment of a location transmitting device in accordance with the present invention;

FIG. 3 is a schematic illustration of a base station;

FIG. 4 illustrates a flow chart of a method to create an initial set of dispatch orders for each of a plurality of vehicles in a fleet;

FIG. 5 illustrates a flowchart of a delivery time updating method when new location information is received from a location transmitting devices; and

FIG. 6 illustrates a flowchart of a method in accordance with the present invention for dispatching a vehicle belonging to a fleet to another delivery job.

### DETAILED DESCRIPTION OF THE ILLUSTRATED EMBODIMENTS

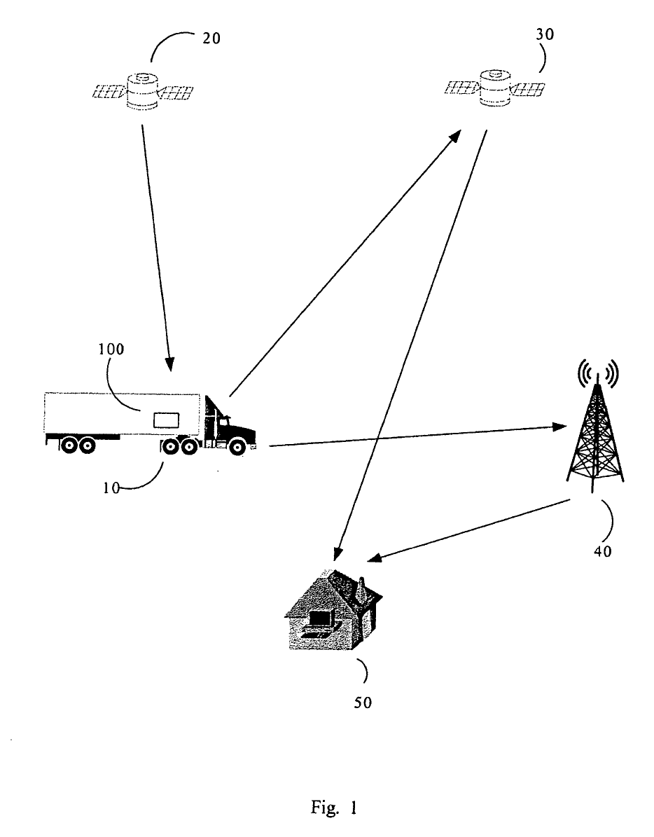

FIG. 1 illustrates a single delivery vehicle 10 of a fleet of delivery vehicles in communication with a base station 50 in accordance with a dispatching system of the present system. The delivery vehicle 10 is equipped with a location transmitting device 100 that can receive global positioning system or GPS coordinates and other data from a GPS satellite network 20. Although FIG. 1 illustrates the GPS satellite network 20 with a single satellite, someone skilled in the art will understand that the GPS satellite network 20 will comprise a plurality of satellites.

The location transmitting device 100 is operative to determine location information using the GPS satellite network 20 and communicate this location information to the base station 50. Typically, the location transmitting device 100 communicates with the base station 50 using a cellular carrier service 40 or a satellite carrier service 30 as shown in FIG. 1, although a person skilled in the art will appreciate that there are other suitable methods of transmitting this location information from the location transmitting device 100 to the base station 50, including radio communication, wireless internet connection, etc.

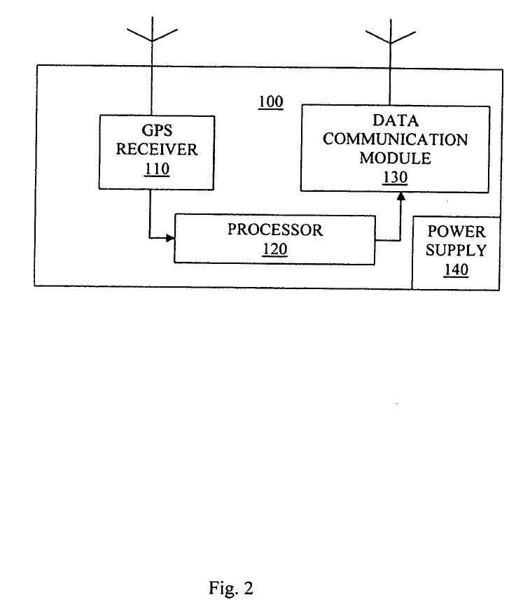

FIG. 2 is a schematic illustration of a location transmitting device 100, in accordance with the present invention. The location transmitting device 100 comprises: a Global Positioning System or GPS receiver 110; a processor 120; a data communication module 130; and a power supply 140.

The GPS receiver 110 is operative to determine location information of the location transmitting device 100. The GPS receiver 110 uses the GPS satellite network 20, illustrated in FIG. 1, to determine location information of the location transmitting device 100. Typically, this location information comprises: coordinates of the location transmitting device 100; a speed of the location transmitting device 100; a direction of travel for the location transmitting device 100; and a time stamp. Because the location transmitting device 100 is installed in a vehicle, the location information determined by the GPS receiver 110 will, for all practical purposes in relation to the present invention, coincide with the vehicle the location transmitting device 100 is installed in.

The processor 120 is operative to receive location information from the GPS receiver 110 and transmit this location information to a base station using the data communication module 130 at predetermined intervals.

The data communication module 130 is preferably a cellular transmitter operative to send data from the location transmitting device 100 over a cellular network. Alternatively, the data communication module 130 might send the data over a satellite network, radio signals or wireless network connection. Additionally, the data communication module 130 could be equipped with a receiver as well as a transmitter to receive information and data.

The power supply 140 could be any power source operative to supply the power requirements of the location transmitting device 100, however, typically it would be a plug for a power port as is typically found in vehicles allowing the location transmitting device 100 to me quickly and easily installed or removed from a vehicle or transferred to a different vehicle with minimal effort.

Although other internal components of the location transmitting device 100 are not illustrated, those of ordinary skill in the art will appreciate that many more components and interconnections between them are well known and can be used, including memory buffers to temporarily store data, memory storage and physical wiring connections.

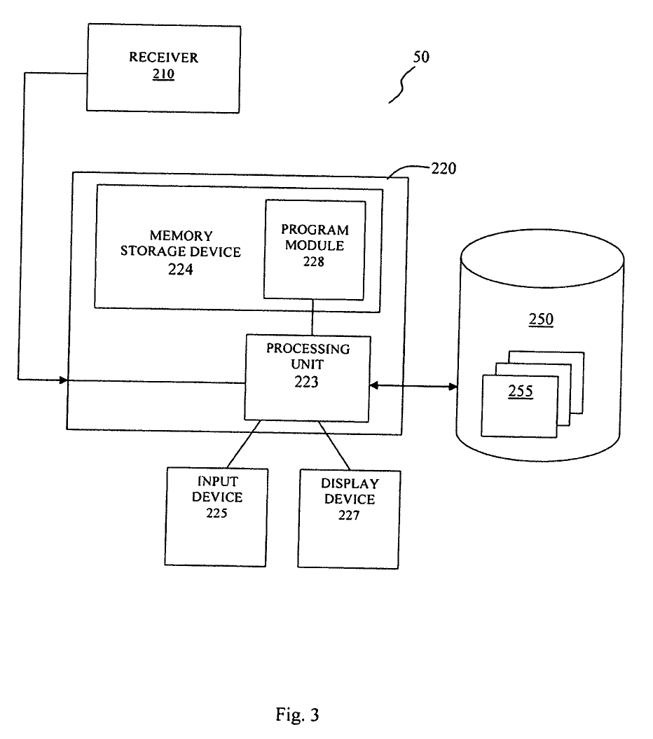

FIG. 3 is a schematic illustration of the base station 50. The base station comprises: a receiver 210; a central computer 220; and a database 250.

The receiver 210 is operative to receive the location information sent by a location transmitting device and send this received location information to the central computer 220.

The central computer 220 would be a conventional computer as typically used in the prior art and operative to run a program comprising: a processing unit 223; a memory storage device 224; an input device 225; a display device 227; and a program module 228.

The processing unit 223 can be any processing unit that is typically known in the art with the capacity to run the program and is operatively connected to the memory storage device 224 such as a local hard-disk, etc. The input device 225 can be any suitable device suitable for inputting data into the central computer 220, such as a keyboard, mouse or data port such as a network connection and is coupled to the processing unit 223 and operative to allow the processing unit 223 to receive information from the input device 225. The display device 227 can be any suitable device coupled to the processing unit 223 and operative for displaying data. The program module 228 is stored in the memory storage device 224 and operative to provide instructions to processing unit 223 and the processing unit 223 responsive to the instructions of the program module 228.

Although other internal components of the central computer 220 are not illustrated, those of ordinary skill in the art will appreciate that many more components and interconnections between them are well known and can be used. As well the central computer 220 need not be limited to only one computer and may comprise a network of connected computer.

The database 250 is connected to the central computer 220 and operative to store data. Although database 250 is illustrated in FIG. 3 as being separate from the central computer 220, a person skilled in the art will understand that database 250 could be incorporated into the central computer 220 as a large memory storage device or alternatively form part of the memory storage device 224.

Typically, the database 250 will comprises a number of records 255. Each record 255 will correspond with a delivery job and a load to be picked up and delivered. The record 255 will initially have an initial pick-up location, indicating the location where the load to be picked up is with GPS co-ordinates. When a delivery job is assigned to a particular delivery vehicle and the delivery job is carried out, data can be recorded in this record 255 relating to the delivery job. As the delivery progresses and is finally completed, the record 255 can be updated with: a unit identifier, indicating the vehicle and/or location transmitting device used in the delivery job; a driver identifier, indicating the driver on the delivery job; a loading time, indicating the time taken to load the delivery at the pick up location; delivery times, indicating any relevant times in the delivery process, including the overall delivery time, time to the pickup location, time from the pickup location, etc.; delivery mileage; delivery route and any related time stamps.

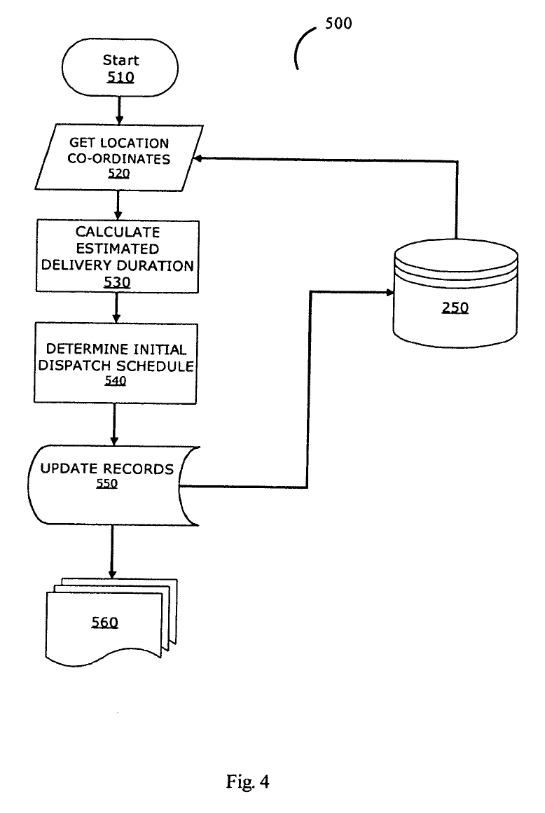

FIG. 4 illustrates a flow chart of an initial dispatching method 500 for determining and creating an initial set of dispatch orders for a plurality of vehicles in a fleet.

Typically, a delivery fleet will begin with a number of delivery jobs to perform with a set number of delivery vehicles in a fleet. Each delivery job will usually comprise: a pickup location, where a load or cargo has to be loaded onto the vehicle; and a delivery location, where a load or cargo has to be delivered to and unloaded from the vehicle. Depending upon what type of deliveries are being made, the delivery location could be the same for many if not all of delivery jobs, such as an agricultural commodity processing plant where all the delivery vehicles will deliver a load to the processing plant and therefore the delivery location will be a bottleneck point because only so many delivery vehicles will be able to unload at the delivery location at one time. Alternatively, the pickup location can be the same for many if not all of the delivery jobs, such as where cement is being delivery from a cement plant and each delivery vehicle will have to pickup a load at the pickup location and therefore the pickup location will be a bottleneck point because the number of delivery vehicles that can be loaded at the pickup location will be limited.

Before the method begins, the locations of each of the pickup locations and delivery locations will be collected and stored in the database 250 and each of the delivery vehicles in the fleet will be provided with a location transmitting device, such as the locating transmitting device 100 illustrated in FIG. 1. Typically, there will be more delivery jobs than delivery vehicles in the fleet so that delivery vehicles in the fleet will be assigned to a series of different delivery jobs, with each delivery vehicle being assigned to another delivery job after they have completed a previous delivery job.

The central computer 220 of the base station 50 will run the initial dispatch method 500. The initial dispatch method 500 will start 510 and the central computer 220 will get the coordinates of each of the pickup locations 520 for each of the delivery jobs to be performed from the database 250. If each delivery job to be performed is stored in a record 255 in the database 250, the record 255 will typically have an initial location identifier indicating the GPS coordinates of the pickup location. Optionally, if there are different delivery locations for different delivery jobs, the central computer 220 can also get the coordinates of the different delivery locations for each of delivery jobs at the same time it gets the pickup location 520.

Next, the central computer 220 calculates an estimated delivery duration for each of the delivery jobs 530. The central computer 220 uses the coordinates of all pickup locations it received 520 to calculate the estimated delivery duration 530 for each of the delivery jobs. The estimated delivery duration will typically be the time for the delivery vehicle to travel to the pickup site, load the cargo at the pickup location and deliver the cargo to a delivery location. The central computer 220 will estimate the travel time to the pickup location, the amount of time required to load the cargo at the pickup location and the travel time for the vehicle delivering the load to the delivery location.

After the central computer 220 has calculated the estimated delivery times for each of the delivery jobs to be done 530, the central computer 220 will then determine an initial dispatch schedule 540 for the fleet of delivery vehicles. The central computer 220 attempts to create a dispatch schedule that will have the delivery vehicles scheduled, based on the estimated delivery times for each of the delivery jobs, to arrive at a bottleneck point at approximately regular intervals. The bottleneck point will either be the loading location, if many of the delivery vehicles pick up loads at a single location, i.e. a cement plant, or the delivery location, if many of the delivery vehicles delivery loads to the same location, i.e. picking up agricultural commodities from a farm and delivering them to a processing location. Because more than one delivery vehicle will eventually arrive at a bottleneck point, if too many delivery vehicles arrive at the bottleneck point at one time, the extra delivery vehicles will waste time waiting for the first delivery vehicle to load or unload.

Preferably, the dispatch schedule will result in one or two delivery vehicles in line at the bottleneck point at any given time to reduce the downtime at the bottleneck point. If the bottleneck point is the delivery location, preferably there will one or two delivery vehicles in line at the delivery location waiting to unload their cargo so that the delivery location can constantly be unloading without major breaks in the delivery vehicles arriving with their deliveries. Alternatively, where the pickup locations serves as the bottle neck in the system, i.e. where all or most of the delivery vehicles have to pick up loads at a single pickup location, the dispatch schedule can attempt to schedule the dispatch of the delivery vehicles so that they arrive at the pickup location at approximately regular intervals related to the time to load the delivery vehicle.

Alternatively, if the bottleneck point allows more than one delivery vehicle to either load or unload at one time, for example, where a delivery location has more than one loading bay, the dispatch schedule can try to optimize the scheduling of the delivery vehicles arriving at the bottleneck point so that more than two delivery vehicles are scheduled to be at the bottleneck point being loaded or unloaded.

The central computer 220 uses the estimated delivery durations determined at 530 for each of the delivery jobs to dispatch the delivery vehicles such that the delivery vehicles arrive at the bottleneck point at regular intervals rather than in bunches. For example, if it takes a delivery vehicle approximately 15 minutes to unload a cargo at a delivery location, in the initial dispatch scheduling, the central computer 220 may assign the delivery vehicles to delivery jobs with estimated times of delivery 15 minutes apart, in attempt to have the delivery vehicles arrive at the delivery location in 15 minute intervals. This would typically be done by the system scheduling the delivery job with the shortest estimate time of delivery to the first vehicle, and then assigning a delivery job with an estimated delivery time 15 minutes longer then the previous assigned delivery job to each subsequent vehicle in the fleet until each of the vehicles in the fleet is assigned a delivery job.

After the central computer 220 has determined an initial dispatch schedule 540, the central computer will update the records 550 in the database 250. The database 250 can be updated with: the estimated delivery duration for each of the delivery jobs; which of the delivery jobs are currently assigned to a delivery vehicle; and which delivery vehicles is assigned to which delivery job. For each delivery job, the record 255 associated with a delivery job can be updated with an estimate duration time for the delivery job. For delivery jobs that have been assigned to a delivery vehicle, the record 255 associated with the delivery job can be updated with: a unit identifier, identifying the delivery vehicle and/or the location transmitting device; a driver identifier, identifying the driver of the delivery vehicle and an estimated time of arrival at a bottleneck point in the delivery job.

Finally, the central computer 220 will output the dispatch orders for each of the delivery vehicles in the fleet 560. Although the method 500 illustrated in FIG. 4 specifically illustrates that a set of dispatch orders is generated 560, with each driver of each delivery vehicle in the fleet receiving a printed dispatch order identifying the delivery job they are assigned to perform, it will be understood by someone skilled in the art that there are many different ways possible to notify a driver of one of the delivery vehicles of his dispatch orders including incorporating a display on the location transmitting device located in each vehicle, informing the driver of the pickup location, delivery location or both.

Once the drivers of the vehicles in the fleet have received their dispatch orders and know where the pickup location (and the delivery location if it differs from the dispatch location) is, the drivers can begin the assigned delivery job. The location transmitting devices 100 located in each of the vehicles in the fleet will be transmitting location data to the central computer 220 at periodic intervals.

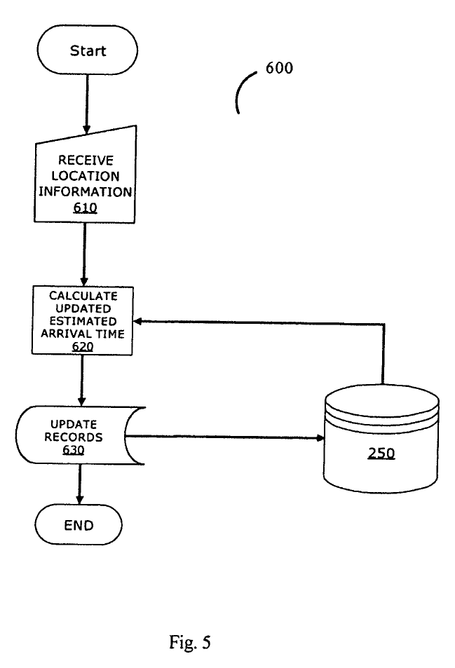

FIG. 5 illustrates a flowchart of a delivery time updating method 600 the central computer 220 will perform when the central computer 220 receives location information from one of the location transmitting devices, such as the location transmitting device 100 illustrated in FIG. 2.

The method 600 starts when the central computer 220 receives location information 610 from a location transmitting device located in one of the delivery vehicles in the fleet. As described above, this location information typically comprises: a delivery vehicle identifier, allowing the system to determine which of the fleet of delivery vehicles the location information is coming from; coordinates of the delivery vehicle; a direction of the delivery vehicle; a speed of the delivery vehicle; and a time stamp.

The central computer 220 then uses the location information received from the location transmitting device 610 to calculate an updated estimated time of arrival at the bottleneck point for the delivery vehicle 620. The location information will allow the central computer 220 to compare the progress of the delivery vehicle to its predicted progress and update the estimated time of arrival at the bottleneck point. For example, the loading of the delivery vehicle at the loading location may have taken less or more time than the central computer 220 originally estimated, or the delivery vehicle for reasons of traffic or delay could be taking longer to travel to and from the loading location. Alternatively, the driver of the delivery vehicle could have simply stopped or taken the delivery vehicle down a different route or got lost. Using the received coordinates of the location transmitting unit (which will correspond to the vehicle) and the speed, the central computer 220 can calculate an updated estimated time of arrival at the bottleneck point. For example, if the location coordinates show that the delivery vehicle has reached the pickup location the estimated time of arrival at the bottleneck point can then be updated to only the estimated time required to load the cargo at the pickup location and travel to the delivery location, if the delivery location is the bottleneck point. Alternatively, if the delivery vehicle is on route to a location and the initial delivery estimate predicted an average speed greater than the actual speeds of the delivery vehicle over the course of the delivery, the central computer 220 can calculate an updated time of arrival at the bottleneck location based on the delivery vehicle's last location along the route and the actual speeds achieved by the delivery vehicle.

Finally, the central computer 220 will save the location information received from the location transmitting device 630 and the updated estimated time of arrival at the bottleneck point in the database 250, for use by the central computer 220 in the future and the method 600 will end 640. The record 255 associated with the delivery job in the database can be updated with the updated estimated time of arrival, the GPS coordinates of the location transmitting device and the time stamp. Additionally, information received from the location transmitting device can be simply stored as an entry in the record 255 providing a complete log of the coordinates, speeds and direction of the delivery vehicle at each of the times it is measured by the location transmitting device and transmitted to the central computer 220.

As each of the delivery vehicles progresses in their assigned delivery jobs, each of the location transmitting devices located in each of the delivery vehicles in the fleet will at predetermined intervals transmit location information data recorded by the location transmitting device to the central computer 220 and the central computer 220 will continue to implement the method 600 each time it receives location information from one of the location transmitting devices, so that each delivery vehicle in the fleet has a fairly current estimated time of arrival at the bottleneck point for the delivery job, each delivery vehicle is currently assigned to. As a delivery vehicles gets closer and closer to the bottleneck point for the delivery job the estimated time of arrival at the bottleneck point will continue to decrease until the vehicle arrives bottleneck location and the estimated time of delivery becomes 0.

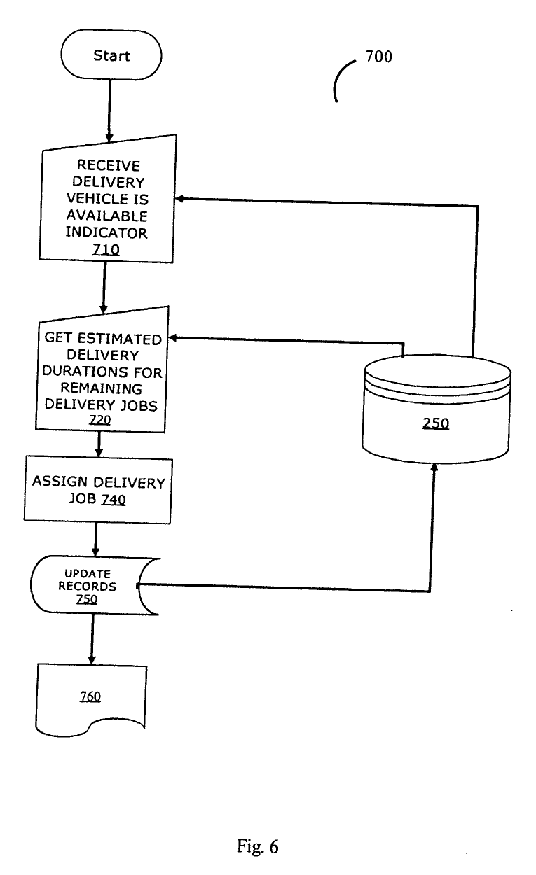

As each delivery vehicle completes the delivery job assigned to it, the delivery vehicle will be dispatched to complete one of the remaining delivery jobs that have not been completed or are not currently being performed by a delivery vehicle of the fleet. FIG. 6 illustrates a method 700 performed by the central computer 220 to dispatch a delivery vehicle, that has completed a previous delivery job, to perform another delivery job. The method 700 begins when the system receives an indication that a specific delivery vehicle in the fleet is available to be dispatched 710 to a next delivery job. The indication might be manually entered into the central computer 220 or it might be send by a remote unit. Additionally, the central computer 220 can be notified that the delivery vehicle is ready to be dispatched to another delivery job at a number of different times, including: when the delivery vehicle arrives at the unloading location; when the delivery vehicle finishes unloading at the loading location; or any other time you wish, i.e. after a period of a break, repairs or refueling after reloading.

The central computer 220 will get the information for the remaining delivery jobs including the estimated delivery duration calculated for each of the remaining delivery jobs 720. The system will then also get the updated estimated times of arrival at the bottleneck point for the delivery jobs currently assigned to delivery vehicles and in progress 730.

Using the estimated delivery times for the remaining delivery and the estimated time of arrival at the bottleneck point for the delivery jobs in progress, the system will determine a dispatch order for the delivery vehicle 740. The central computer 220 will attempt to match the delivery vehicle with a remaining delivery job that makes the most efficient use of the delivery schedule. For example, if the estimated time of arrival at the bottleneck point for the delivery jobs currently being performed end at regular intervals for the next couple hours, the system will choose to dispatch the delivery vehicle on a delivery job with an estimated delivery duration that schedules the delivery vehicle to arrive at the bottleneck point beyond the next couple hours to prevent too many delivery vehicles arriving at the bottleneck point at one time. Alternatively, if there are delivery vehicles with estimated delivery durations that have the delivery vehicles scheduled to arrive at the bottleneck point at regular intervals for the next half hour, but then no delivery vehicles are scheduled to arrive at the bottleneck point for more than two hours, the central computer 220 will try to choose a delivery job to dispatch the delivery vehicle to with an estimated delivery duration that has the delivery vehicle arriving at the bottleneck point between a half hour and two hours, to try to keep the delivery vehicles in the fleet arriving at the bottleneck point at approximately regular intervals.

The central computer 220 will then update the records 750 in the database 250, indicating that the delivery vehicle has been dispatched on the delivery job. The record 255 in the database 250 associated with the delivery job will be updated with a unit identifier and a driver identifier corresponding to the delivery vehicle and the driver assigned to the delivery job.

Additionally, if one or more remaining delivery jobs have the same pickup location, as the delivery job that was just completed, and the bottleneck point is the delivery location or one or more remaining delivery jobs have the same delivery location, as the delivery job that was just completed, and the bottleneck point is the pickup location, the central computer 220 can update the record 255 of the remaining delivery job or delivery jobs so that the estimated delivery duration is based on the actual times of the recently completed delivery job. In this manner, latter delivery jobs that will follow the same route as already completed delivery jobs can have the estimated delivery times updated using actual delivery times based, rather than on calculated estimates by the central computer 220, but on actual real world times. In this manner, real world constraints on the delivery job, i.e. weather, traffic, etc., can be taken into account for latter delivery jobs, increasing the accuracy of latter estimated delivery durations.

Finally, the system will output the dispatch order 760. Although method 700 in FIG. 6 illustrates that a printed dispatch order is output, there are many other ways the dispatch order can be communicated to the driver of the delivery vehicle.

As each delivery vehicle in the fleet completes a delivery job, the central computer 220 will dispatch the delivery vehicle on one of the remaining delivery job using the method 600, until all of the delivery jobs have been completed. After each delivery job is completed, the record 255 in the database 250 will contain information relating to the delivery job that can be used at a later time.

Also disclosed, as a portion of the present invention, is the general method of dispatching delivery vehicles on a plurality of delivery jobs, as disclosed by the various methods and steps outlined above. The general method attempts to have delivery vehicles arrive at a delivery location at approximately regular intervals. The general method involves the steps of: determining an initial dispatch schedule and dispatching delivery vehicles in a fleet on delivery jobs in accordance with the initial dispatch schedule; monitoring the progress of each of the delivery vehicles on a delivery job; and, when a delivery vehicle has completed a delivery job, based on the information known about all of the other delivery jobs being completed by the other delivery vehicles from monitoring the progress of each of the delivery jobs, assigning another delivery job to the delivery vehicle.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A system for automatically dispatching a plurality of delivery vehicles on a plurality of delivery jobs, the system comprising:
a plurality of tracking devices operative to transmit the location information over a wireless communication medium, wherein a location tracking devices is located in each delivery vehicle;
a receiver operative to receive location information from the plurality of location tracking devices; and
a computer operatively connected to the receiver, the computer comprising: a processing unit; a memory storage device operatively connected to the processing unit; and a program module stored in the memory storage device operative for providing instructions to the processing unit, the processing unit responsive to the instructions of the program module, the program module operative for:
calculating an estimated delivery duration for each of the delivery jobs;
determining an initial dispatch schedule, wherein each of the delivery vehicles is assigned a delivery job based on the estimated delivery duration calculated for the delivery job, wherein the estimated delivery durations are coordinated such that the delivery vehicles are scheduled to arrive at a bottleneck point at intervals;
during the course of each assigned delivery job, regularly receiving location information transmitted by each of the location tracking devices and using the location information to calculate an updated estimated time of arrival at the bottleneck point; and
when a delivery vehicle completes an assigned delivery job, using the estimated delivery durations of the remaining delivery jobs and the updated estimated times of arrival at the bottleneck point of the delivery jobs in progress, assigning a remaining delivery job to the delivery vehicle such that the estimated delivery duration of the delivery job has the delivery vehicle scheduled to arrive at the bottleneck point at an interval with respect to the delivery jobs in progress.

2. The system of claim 1, wherein the bottleneck point is a pickup location whereby a delivery vehicle receives a vehicle load to be transferred to a delivery location.

3. The system of claim 1, wherein the bottleneck point is a delivery location whereby a delivery vehicle delivers a vehicle load to the delivery location.

4. The system of claim 1, wherein each of the location tracking devices comprises a connection for a power port in a delivery vehicle and is operative to be temporarily installed in the delivery vehicle.

5. The system of claim 1, comprising a printer and wherein a driver of a delivery vehicle is assigned a delivery job by the delivery job being printed out on the printer and provided to the driver.

6. The system of claim 1, wherein at least one of the location tracking devices is provided with a display screen and a delivery vehicle is assigned a delivery job by indicating the delivery job on the display screen.

7. The system of claim 1, wherein the plurality of location tracking devices comprise a GPS receiver whereby the location tracking device can generate location information using the GPS receiver.

8. The system of claim 1, wherein the location information comprises: coordinates of the location tracking device; a speed of the location tracking device; a direction of travel of the location tracking device and a time stamp.

9. The system of claim 1, wherein the wireless carrier medium is a cellular service.

10. The system of claim 1, wherein the wireless carrier medium is a satellite service.

11. The system of claim 1, comprising a database operatively connected to the computer, the database containing a record associated with each delivery job and information associated with a delivery job is stored in the associated record.

12. The system of claim 11, wherein a record initially comprises a pickup location and a delivery location and when the delivery route associated with the record is assigned to one of the delivery vehicles, the record is updated with: a vehicle identifier, indicating the delivery vehicle that is assigned the delivery job.

13. The system of claim 12, wherein after the location information is received from each location tracking device, the location information is stored in the record associated with the delivery job assigned to the delivery vehicle the location tracking device is located in and an updated estimated time of arrival at the bottleneck point is stored in the record.

14. The system of claim 2, wherein there is a first delivery job and a second delivery job with the same delivery location and after the first delivery job is completed, the estimated delivery duration of the second delivery job is updated using an actual delivery duration of the first delivery job.

15. The system of claim 3, wherein there is a first delivery job and a second delivery job with the same pickup location and after the first delivery job is completed, the estimated delivery duration of the second delivery job is updated using an actual delivery duration of the first delivery job.

16. A method for automatically dispatching a plurality of vehicles on a plurality of delivery jobs, the method comprising:
calculating an estimated delivery duration for each of the delivery jobs;
determining an initial dispatch schedule, wherein each of the delivery vehicles is assigned a delivery job based on the estimated delivery duration calculated for the delivery job, wherein the estimated delivery durations are coordinated such that the delivery vehicles are scheduled to arrive at a bottleneck point at intervals;
during the course of each assigned delivery job, regularly receiving location information from a location tracking device located in each of the delivery vehicles and using the location information to calculate an updated estimated time of arrival at the bottleneck point; and
when a delivery vehicle completes an assigned delivery job, using the estimated delivery durations of the remaining delivery jobs and the updated estimated times of arrival at the bottleneck point of the delivery jobs in progress, assigning a remaining delivery job to the delivery vehicle such that the estimated delivery duration for the delivery job has the delivery vehicle scheduled to arrive at the bottleneck point at an interval with respect to the delivery jobs in progress.

17. The method of claim 16, wherein the bottleneck point is a pickup location whereby a delivery vehicle receives a vehicle load to be transferred to a delivery location.

18. The method of claim 16, wherein the bottleneck point is a delivery location whereby a delivery vehicle delivers a vehicle load to the delivery location.

19. The method of claim 16, wherein each of the location tracking devices comprises a connection for a power port in a delivery vehicle and is operative to be temporarily installed in the delivery vehicle.

20. The method of claim 16 wherein a driver of a delivery vehicle is assigned a delivery job by the delivery job being printed out on a printer and provided to the driver.

21. The method of claim 16, wherein a driver of a delivery vehicle is assigned a delivery job by providing a display screen on the location tracking device and displaying, on the display screen, the delivery job.

22. The method of claim 16, wherein the location tracking device comprises a GPS receiver whereby the location tracking device can generate location information using the GPS receiver.

23. The method of claim 16, wherein the location information comprises: coordinates of the location tracking device; a speed of the location tracking device; a direction of travel of the location tracking device and a time stamp.

24. The method of claim 16, wherein a record is created in a database for each of the delivery jobs.

25. The method of claim 24, wherein each record initially comprises a pickup location and a delivery location and when the delivery route associated with the record is assigned to one of the delivery vehicles, the record is updated with: a vehicle identifier, indicating the delivery vehicle that is assigned the delivery job.

26. The method of claim 25, wherein after the location information is received from each location tracking device, the location information is stored in the record associated with the delivery job assigned to the delivery vehicle the location tracking device is located in and an updated estimated time of arrival at the bottleneck point is stored in the record.

27. The system of claim 17, wherein there is a first delivery job and a second delivery job with the same delivery location and after the first delivery job is completed, the estimated delivery duration of the second delivery job is updated using an actual delivery duration of the first delivery job.

28. The system of claim 18, wherein there is a first delivery job and a second delivery job with the same pickup location and after the first delivery job is completed, the estimated delivery duration of the second delivery job is updated using an actual delivery duration of the first delivery job.

29. A computer readable memory having recorded thereon statements and instructions for execution by a computer to carry out the method of claim 16.
